(19) United States
(12) Patent Application Publication
(10) Pub. No.: US 2014/0247186 A1
(43) Pub. Date: Sep. 4, 2014

(54) Global Navigation Satellite System (GNSS) Anti-Interference using Array Processing

(71) Applicant: UTI LIMITED PARTNERSHIP, Calgary (CA)

(72) Inventors: Saeed Daneshmand, Calgary (CA); Ali Jafarnia-Jahromi, Calgary (CA); Ali Broumandan, Calgary (CA); John Nielsen, Calgary (CA); Gérard Lachapelle, Calgary (CA)

(73) Assignee: UTI LIMITED PARTNERSHIP, Calgary (CA)

(21) Appl. No.: 14/061,933

(22) Filed: Oct. 24, 2013

Related U.S. Application Data
(60) Provisional application No. 61/719,260, filed on Oct. 26, 2012.

(51) Int. Cl. G01S 19/21

(52) U.S. Cl. CPC G01S 19/215
USPC 342/357.59

(57) ABSTRACT

Embodiments of the invention are directed to GNSS anti-interference using array processing. In one embodiment, a device may be configured to receive signals GNSS signals. In one embodiment, the signals may include a superposition of GNSS signals from independent transmitter sources and a spoofing signal. The spoofing signal may include several pseudo random noise (PRN) codes originating from a single transmitter source. In a one embodiment, the device may include multiple radio frequency (RF) inputs connected to multiple antennas and may use a combining algorithm to produce a weighted sum of the antenna outputs. The resultant sum may be passed through an output port of the device that is configured to be coupled to an RF input port of a GNSS receiver.

### TECHNICAL FIELD

Embodiments of the invention are generally directed to navigation and positioning and, more specifically for Global Navigation Satellite System (GNSS) anti-interference using array processing.

### BACKGROUND

GNSS signals are vulnerable to in-band interference such as jamming and spoofing signals. A spoofer sends an intentionally interfering signal that aims to force GNSS receivers into generating false position/navigation solutions. A spoofing attack is more dangerous than jamming since the target receiver is not aware of the threat. The rapid advance in software defined radio (SDR) technology has made GNSS spoofers and jammers more flexible and less costly; therefore, GNSS interferers can be made available for civilian misapplications at a low cost.

### SUMMARY

Embodiments of the invention are directed to GNSS anti-interference using array processing. In one embodiment, a device may be configured to receive GNSS signals. The signals may include a superposition of GNSS signals from independent transmitter sources and a spoofing signal. The spoofing signal may include several pseudo random noise (PRN) codes originating from a single transmitter source. In one embodiment, the device may include multiple radio frequency (RF) inputs connected to multiple antenna elements in an array and may use a combining algorithm to produce a weighted sum of the antenna outputs. The resultant sum may be passed through an output port of the device that is configured to be coupled to an RF input port of a GNSS receiver.

In one embodiment, the device may include RF to Intermediate Frequency (IF) down-convertors (D/C). A plurality of RF IF down-converters corresponding to each antenna element may be used in order to down-convert the frequency band of each of the received GNSS signals (from RF) to a lower band (IF). Additionally, the device may include an Analog to Digital Converter (ADC). A plurality of ADCs corresponding to each D/C may sample the input IF signals into digital domain. The device may also include a processing unit. The processing unit may be configured to receive several ADC outputs and apply a combining algorithm in order to generate a single output signal. Also, the device may include a Digital to Analog Converter (DAC). In one embodiment, a single digital to analog converter corresponding to the output of the processing unit that converts the output digital samples into an IF analog signal. In one embodiment, the device includes an IF to RF up-convertor (U/C). The U/C module may up-convert the IF signal output of the DAC unit into an RF signal. In a particular embodiment, the device may be a stand-alone inline device.

In another embodiment, the device may be configured to have multiple inputs and multiple outputs. The multiple inputs may be combined using a combining algorithm to produce a plurality of weighted sums of the antenna outputs. In such an embodiment, the weighted sums may be passed through a plurality of output ports that are configured to be connected to RF input ports of a GNSS receiver comprising of a plurality of input ports. In such an embodiment, the device includes a plurality of D/C blocks, a plurality of ADC blocks, a processing unit, a plurality of DAC blocks corresponding to different IF outputs of the processing unit, and a plurality of IF to RF up-converters corresponding to the plurality of DACs. In one embodiment, the processing unit may be configured to receive the digitized IF signals corresponding to different ADCs and perform processing to generate multiple IF digital outputs.

In one embodiment, the processor may calculate pairwise numerical correlations of the digitized outputs from the antenna with a single digitized channel selected from the same set of inputs to compute weighting coefficients that are applied to the input signals resulting in a weighted combined output. For example, if there are N input antennas, the pairwise correlations are generated between one of these antennas and the remaining N−1 antennas. This results in N−1 correlation sums. These correlation sums may be used to estimate the spatial characteristics of the dominant undesired signal to form the orthogonal projection matrix onto the spoofing subspace. This matrix may be used to compute weighting coefficients that are applied to the processing unit inputs resulting in a weighted combined output that is passed to the DAC.

In another embodiment, pairwise numerical correlations of the plurality of digitized inputs with a single input selected from the same set of inputs are calculated, and the correlations are used to compute a plurality of weighting coefficients based on the orthogonal projection matrix that are applied to the plurality of inputs resulting in a plurality of weighted combined outputs. For example, if there are N antennas of the device then there are N−1 correlations where these correlations are used to estimate the spatial characteristics of the dominant undesired signal to form the orthogonal projection matrix onto the spoofing subspace. This matrix is then used to generate a plurality of weighting coefficient sets that are applied to inputs of the processing unit for the device resulting in a plurality of combined spoofing free outputs.

In one embodiment, the weighting coefficients are calculated based on (I) the absolute values of pairwise correlations of all the inputs with a delayed version of a single input selected from the same set of inputs, and (II) the pairwise correlations described above. The computed weighting coefficients are applied to the plurality of inputs resulting in a weighted combined output. For example, in the case of N antennas, first the correlation of the signal of each antenna with a delayed version of the received signal from a reference antenna, which is selected from the same set of antenna, is calculated. Specifically, N correlations are generated. Second, the pairwise numerical correlations of all the antenna outputs with the reference antenna are calculated. The absolute values of the first set of correlations in conjugation with the phase of the second set of correlations are employed to form an orthogonal projection matrix onto the spoofing subspace. This matrix is used to compute weighting coefficients that are applied to the inputs of the processing unit in embodiments with a single output.

Similarly, the correlation sums may be calculated and the orthogonal projection matrix is employed to compute a plurality of weighting coefficient sets for the embodiment with a plurality of outputs.

In one embodiment, the device receives a superposition of GNSS signals from independent transmitter sources and a spoofing signal and its several multipath reflections originating from a single transmitter source. In such an embodiment, the device may include multiple antennas and use a combining algorithm to produce a weighted sum of the down-converted antenna outputs with the resultant sum passed through the output up-converter which is coupled to the output port of the device that can be connected to RF input port of a conventional GNSS. The processor may then calculate pairwise numerical correlations of the IF inputs for a certain time interval, where these correlation sums are assembled into a covariance matrix where the covariance matrix is used to generate the combining weights and where the weighted sum is passed to the output port of the processing unit. For example, given N input antennas and for P consecutive snapshots NP(NP+1)/2 pairwise numerical correlations are generated based on the down-converted signal inputs. These are used to create an NP by NP covariance matrix. This covariance matrix is used for calculating the combining weights that are applied to the N received input samples to suppress the spoofing interference signal and its received multipath components which are the dominant received source of power.

In an embodiment, the processing unit may apply a modified version of the outer product decomposition algorithm (OPDA), constrained optimization method or other linear prediction methods or the subspace method to the covariance matrix in order to estimate the spatial characteristics of the line of sight spoofing signal and its multipath reflections to form the orthogonal projection matrix onto the spoofing subspace. In such an embodiment, these algorithms may be able to estimate the potential spatial characteristic of the reflected signals for different time delays.

In one embodiment, the processing unit compares the spatial characteristics of the multipath reflections for each delay to a threshold to detect and estimate the spatial characteristics of the potential reflections of the spoofing signal. Then, all the spatial characteristics of the line of sight spoofing signal and its potential reflections are used to form the orthogonal projection matrix used to compute weighting coefficients that are applied to the processing unit inputs resulting in a weighted combined output. The weights may only be calculated for those delays whose corresponding power is above the threshold. The LOS component may always be at delay ‘0’ in some embodiments.

When the multipath reflections are received with delays less than one chip duration of the GNSS signal (e.g., the GPS C/A code has a chip duration of 1 μsec) or when no reflection is present, the processing unit may compute pairwise numerical correlation sums of the input IF samples. In one embodiment, the correlation sums are assembled into a covariance matrix, where the eigenvector corresponding to the second largest eigenvalue of this covariance matrix is used as combining weights and where the weighted sum is passed to the output port of the processing unit. For example, instead of computing NP(NP+1)/2 pairwise numerical correlations, only N(N+1)/2 pairwise numerical correlations are generated based on the IF signal inputs. These are used to create an N by N covariance matrix. The eigenvalues of this covariance matrix are computed along with the corresponding eigenvectors. The dominant eigenvalue corresponds approximately to the stronger spoofing interference signal. Thus, selecting input weights that are orthogonal to the eigenvector corresponding to the dominant eigenvalue will suppress the spoofing interference signal from the output. In one embodiment, the weights are selected to correspond with the eigenvector of the second most dominant eigenvalue. The weighted output may be passed to the single output port of the processing unit in some embodiments.

In a further embodiment, a second output of the processing unit is generated from a weighting based on the 3rd largest eigenvalue resulting in two output ports of the device. One difference from other embodiments, is that an additional eigenvector weighting corresponding to the 3rd most dominant eigenvector is computed in addition to the output. These outputs give independent diversity combinations of the remaining authentic signals. This is of relevance as many GNSS receivers have provision for two input antennas for antenna diversity processing. In an embodiment, the Eigen weighting processing of the pre-processing block does not conflict with the diversity processing of the conventional two antenna input GNSS receiver. In a further embodiment, the 2nd to the Nth eigenvectors corresponding to the 2nd to the Nth largest eigenvalues are used as weighting coefficients forming N−1 outputs based on the device having N antennas.

In one embodiment, the device further includes a pre-processing block to normalize the amplitude of the input signals such that the variances of the outputs of the antennas are the same. The signal power emanating from the each individual antenna may be normalized to a specified level prior to forming the correlation pairs and covariance matrix.

Further, the device may include a user control input that in one position performs the processing methods described above, and in the other position bypasses the weighting and connects one or more of the input antennas to one or more of the output ports to the GNSS receiver. Alternatively, the manual switch may be replaced by an automatic spoofer sensing device such that if a spoofer is detected then the processing of the previous claims is invoked and if no spoofer is detected then the processing is bypassed. In such embodiments, spoofing detection could be based on a measurement of the signal strength at the output of the N input antennas or it could be based on feedback from the GNSS receiver.

In this disclosure, the following notation is adopted. Bold letters stand for vectors and capital bold letters stand for matrices.

( )^{H}: Complex conjugate transpose

### ( )^{T}: Transpose

### ( )^{*}: Conjugate

(A)⁻¹: Inverse of matrix A
E{ }: Statistical expectation
∥a∥: Norm of vector a
∠x: Phase of complex value x
|x|: Amplitude of complex value x
⊥: Orthogonal projection
a·b: Denotes the inner product of a and b
I: Identity matrix
0: All zero vector

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a GNSS system that includes a spoofing device.

FIG. 2 is a schematic block diagram of one embodiment of a GNSS device having an anti-spoofing unit.

FIG. 3 is a schematic diagram illustrating one embodiment an antenna array configuration for use with the present embodiments.

FIG. 4A is a schematic block diagram of a GNSS system which describes an embodiment of the anti-spoofing unit in greater detail.

FIG. 4B is a schematic block diagram of a GNSS system which describes an alternative embodiment of an anti-spoofing device.

FIG. 5 is a schematic block diagram describing one embodiment of functional blocks that may be implemented in an anti-spoofing device.

FIG. 6 is a schematic block diagram illustrating one embodiment of a GNSS system in a multipath environment.

### DETAILED DESCRIPTION

The present embodiments are described in the context of a single antenna spoofing scenario where the spoofing transmitter is emitting several GPS-like signals that have similar temporal and spectral characteristics as the authentic GPS signals. Furthermore, their power level is also comparable to that of the authentic GPS signals which is under the noise floor.

In the present embodiments, a spatial processing method utilizing an antenna array 201 is described to suppress the spoofing signal at a low computational complexity. This technique performs spoofing mitigation before despreading the received signals. Operation of this method is based on scenarios where all spoofing signals are received from a similar direction and the authentic signals are received from different satellites at different directions. In one embodiment, the method detects the space sector from which the spoofing signals are received and then performs a spatial filtering to discard the spoofing signal. An embodiment of the system includes an antenna array that has two or more antenna elements. One advantage of the described methods is that antenna array calibration may be avoided. Embodiments of the system include a standalone inline device that connects the antenna array to a GNSS receiver; therefore, there is no need to modify the structure of conventional receivers. Additionally, this technique can be integrated with, e.g., next generation of anti-spoofing GNSS receivers.

The spoofing signals may be, for example, transmitted from terrestrial antennas; therefore, they are exposed to multipath propagation. As a consequence, the spoofing signal is not received from a single direction anymore and its reflections also can mislead a GNSS receiver. Thus, the present embodiments are also described in the context of a multipath environment. To this end, temporal processing may be incorporated in conjugation with the spatial processing. Furthermore, using this technique, the reflection of the spoofing signal can be detected much more easily compared to the case of spatial processing only.

The present embodiments have several advantages over the prior art, including low computational complexity, standalone operation, no array calibration is required, both Line of Sight (LOS) and multipath components of a spoofing signal may be eliminated, a direct relationship between spoofing signal power and mitigation, and the present embodiments may be faster than prior methods.

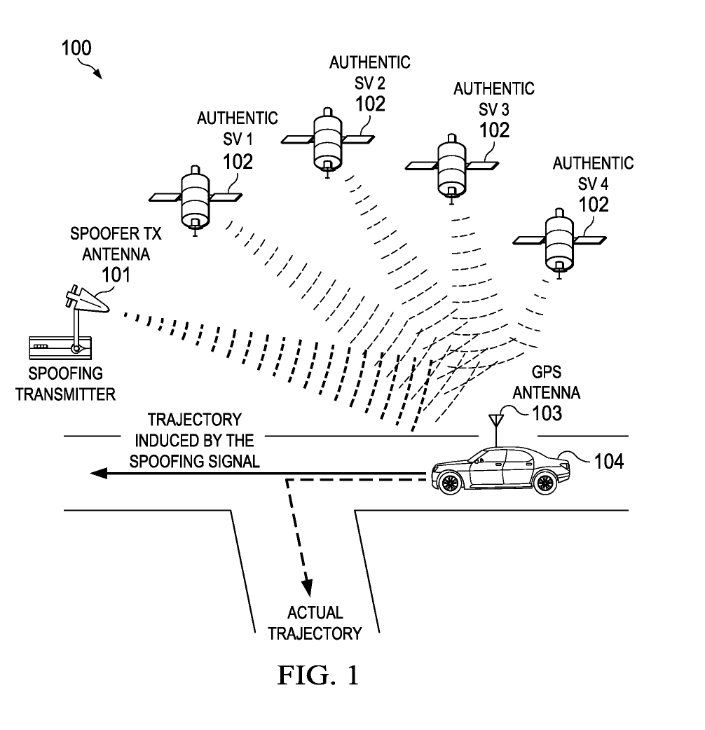

FIG. 1 is a schematic block diagram of a GNSS system 100 that includes a spoofing device 101. As illustrated, an embodiment of a GNSS system 100 may include a plurality of satellites 102 providing true GNSS signals. The system 100 may also include a GPS/GNSS device 103 configured to receive the true GNSS signals from the satellites 102. The GPS/GNSS device 103 may be coupled to, for example, a vehicle 104 such as an automobile, an aircraft, a watercraft, or the like. The GPS/GNSS device 103 may provide navigation information to the vehicle 104 or to an operator thereof. The system 100 may also include one spoofing device 101 configured to transmit spoofing signals to the GPS/GNSS device 103 with the intent of interfering with the navigation information provided by the GPS/GNSS device 103. The present embodiments may be used in combination with, or integrated with the GPS/GNSS device 103 to mitigate the effects of the spoofing signals transmitted by the spoofing device 101.

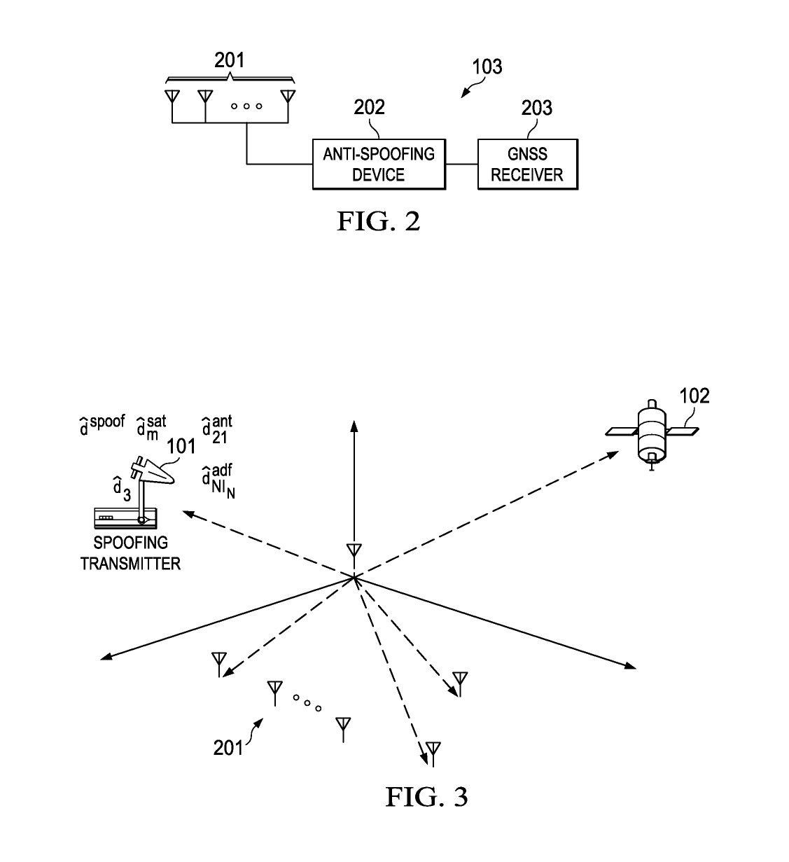

For example, FIG. 2 is a schematic block diagram of one embodiment of a GNSS device 103 having an anti-spoofing unit 202. In such an embodiment, the GNSS device 103 may include an antenna array 201, an anti-spoofing unit 202 coupled to the antenna array 201, and a GNSS receiver 203 coupled to the anti-spoofing unit 202.

In some embodiments, the spoofer 101 is a point source transmitting several PRN codes, each of which having a comparable power level to that of the authentic signals. Therefore, the overall spatial energy of the spoofing signals provided by the spoofer 101 is considerably higher than that of the authentic ones provided by the satellites 102. This common feature of spoofing attacks and the inherent periodicity of authentic and spoofing signals, which employ periodic PRN codes in their structures, have been utilized in order to steer a null toward the direction where the signal with the highest amount of spatial energy (spoofing signals) is impinging on the antenna array 201. One of the benefits of the present embodiments is that it does not require array calibration or knowledge of the antenna array 201 configuration and orientation.

To further improve the performance of this beamformer, the proposed approach has been extended to the case that aims to not only steer a null toward the spoofing signals but also maximize the power of each authentic signal. This process also avoids the unintentional attenuation of some of authentic signals occurring in the null steering process.

In one embodiment, the GPS/GNSS device 103 may include an N-element antenna array 201 configuration. In this configuration, one antenna is chosen as the reference antenna. The reference coordinate system may be located at the reference antenna (r₁) as shown in FIG. 3. The complex baseband representation of N received spatial samples of authentic and spoofing signals impinging on the antenna array before despreading can be written in vector form as

$$r ( {nT}_{s} ) = {\sum }_{m = 1}^{{N}_{Auth}} {a}_{m} \sqrt{{p}_{m}^{a}} {F}_{m}^{a} ( {nT}_{s} ) + b {\sum }_{k = 1}^{{N}_{Spoof}} \sqrt{{p}_{k}^{s}} {F}_{k}^{s} ( {nT}_{s} ) + η ( {nT}_{s} ) \qquad ( 1 )$$

where N_{Auth} and N_{Spoof} are the number of authentic and spoofing signals respectively and

Fₘ^{a}(nTₛ)=dₘ^{a}(nTₛ−τₘ^{a})cₘ^{a}(nTₛ−τₘ^{a})e^{jφ}^{ₘ}^{^{a}}^{+j2πf}^{ₘ}^{^{a}},

Fₖ^{s}(nTₛ)=dₖ^{s}(nTₛ−τₖ^{s})cₖ^{s}(nTₛ−τₖ^{s})e^{jφ}^{ₖ}^{^{s}}^{+j2πf}^{ₖ}^{^{s}}^{nT}^{ₛ} (2)

In (1) and (2), the superscripts s and a refer to the spoofing and authentic signals respectively. Tₛ is the sampling interval and φ, f, p and τ are the phase, Doppler frequency, and signal power and code delay of the received signals respectively. In this model, d(nTₛ) and c(nTₛ) represent navigation data bits and PRN code. η is the complex additive white Gaussian noise vector with covariance matrix σ²I. b and aₘ are spatial signature vector (SSV) of spoofing signals and mth authentic signal respectively. They incorporate all spatial characteristics of authentic and spoofing signals which can be written as

b=C b̅

aₘ=Cāₘ (3)

where

$$\overline{b} = [ \begin{matrix}1 \\ {b}_{2} \\ ⋮ \\ {b}_{N}\end{matrix} ] = [ \begin{matrix}{e}^{- j \frac{2 π {d}_{11}^{ant} \cdot {\hat{d}}^{spoof}}{λ}} \\ {e}^{- j \frac{2 π {d}_{21}^{ant} \cdot {\hat{d}}^{spoof}}{λ}} \\ ⋮ \\ {e}^{- j \frac{2 π {d}_{N 1}^{ant} \cdot {\hat{d}}^{spoof}}{λ}}\end{matrix} ] \\ {\overline{a}}_{m} = [ \begin{matrix}1 \\ {( {a}_{m} )}_{2} \\ ⋮ \\ {( {a}_{m} )}_{N}\end{matrix} ] = [ \begin{matrix}{e}^{- j \frac{ 2 π {d}_{11}^{ant} \cdot {\hat{d}}_{m}^{sat}}{λ}} \\ {e}^{- j \frac{2 π {d}_{21}^{ant} \cdot {\hat{d}}_{m}^{sat}}{λ}} \\ ⋮ \\ {e}^{- j \frac{2 π {d}_{N 1}^{ant} \cdot {\hat{d}}_{m}^{sat}}{λ}}\end{matrix} ] \\ C = [ \begin{matrix}1 & 0 & … & 0 \\ 0 & {C}_{2} & … & 0 \\ ⋮ & ⋮ & ⋱ & ⋮ \\ 0 & 0 & … & {C}_{N}\end{matrix} ] \qquad ( 4 )$$

where \hat{d}ₘ^{sat} and \hat{d}_{spoof} are unit vectors pointing from the origin of the coordinate system towards the mth GPS satellite and the spoofer, respectively. dᵢ₁^{ant} is the vector pointing from the origin to the ith antenna phase center and λ is the GPS carrier wavelength at L1 frequency. In (3) and (4), āₘ and b̅ₘ are representing the steering vectors and C is a diagonal complex matrix expressing gain/phase mismatch of the antenna elements in a non-calibrated array structure. As mentioned before, the spoofer 101 transmits several PRN codes from the same direction. Therefore, b is the same for all spoofing signals and hence the index k is omitted in b. Herein, the problem of interest is to find an optimal gain vector which is denoted by f to satisfy the following conditions:

f^{H}b=0

∥f∥≠0. (5)

The constraint avoids the trivial solution which is f=0. Therefore, by applying f to the received antenna array signals, the spoofing signals are suppressed in a beamformer output as

$$\begin{matrix}v ( {nT}_{s} ) = {f}^{H} r ( {nT}_{s} ) \\ = {\sum }_{m = 1}^{{N}_{Auth}} {f}^{H} {a}_{m} \sqrt{{p}_{m}^{a}} {F}_{m}^{a} ( {nT}_{s} ) + \\ {f}^{H} b {\sum }_{k = 1}^{{N}_{spoof}} \sqrt{{p}_{k}^{s}} {F}_{k}^{s} ( {nT}_{s} ) + {f}^{H} η ( {nT}_{s} ) \\ \approx {\sum }_{m = 1}^{{N}_{Auth}} {f}^{H} {a}_{m} \sqrt{{p}_{m}^{a}} {F}_{m}^{a} ( {nT}_{s} ) + {f}^{H} η ( {nT}_{s} ) .\end{matrix} \qquad ( 6 )$$

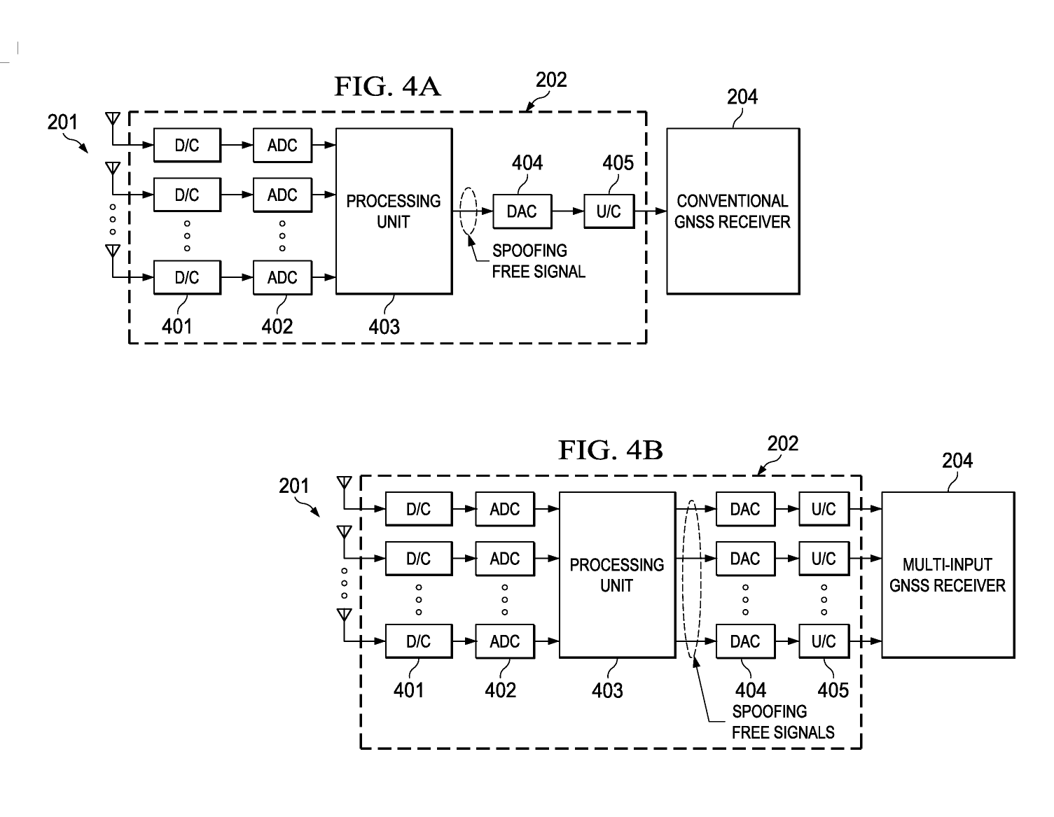

FIG. 4A is a schematic block diagram of a GNSS system 103 which describes an embodiment of the anti-spoofing unit 202 which may be used according to the described methods. In one embodiment, the device 202 may include RF to Intermediate Frequency (IF) down-convertors (D/C) 401. A plurality of RF IF down-converters corresponding to each antenna element in the antenna array 201 may be used in order to down-convert the frequency band of each of the received GNSS signals (from RF) to a lower band (IF). Additionally, the device may include an Analog to Digital Converter (ADC) 402. A plurality of ADCs corresponding to each D/C may sample the input IF signals into digital domain. The device may also include a processing unit 403. The processing unit 403 may be configured to receive several ADC 402 outputs and apply an embodiment of the described combining algorithm in order to generate a single output signal. Also, the device may include a Digital to Analog Converter (DAC) 404. In one embodiment, a single DAC 404 corresponding to the output of the processing unit 403 that converts the output digital samples into an IF analog signal. In one embodiment, the device 202 includes an IF to RF up-convertor (U/C) 405. The U/C 405 module may up-convert the IF signal output of the DAC 404 unit into an RF signal. In a particular embodiment, the device 202 may be a stand-alone inline device.

FIG. 4B is a schematic block diagram of a GNSS system 103 which describes an alternative embodiment of an anti-spoofing device 202. In another embodiment, the device may be configured to have multiple inputs and multiple outputs. The multiple inputs may be combined using a combining algorithm to produce a plurality of weighted sums of the antenna outputs. In such an embodiment, the weighted sums may be passed through a plurality of output ports that are configured to be connected to RF input ports of a GNSS receiver comprising of a plurality of input ports. In such an embodiment, the device includes a plurality of D/C blocks 401, a plurality of ADC blocks 402, a processing unit 403, a plurality of DAC blocks 404 corresponding to different IF outputs of the processing unit, and a plurality of IF to RF up-converters 405 corresponding to the plurality of DACs 404. In one embodiment, the processing unit 403 may be configured to receive the digitized IF signals corresponding to different ADCs 402 and perform processing to generate multiple IF digital outputs.

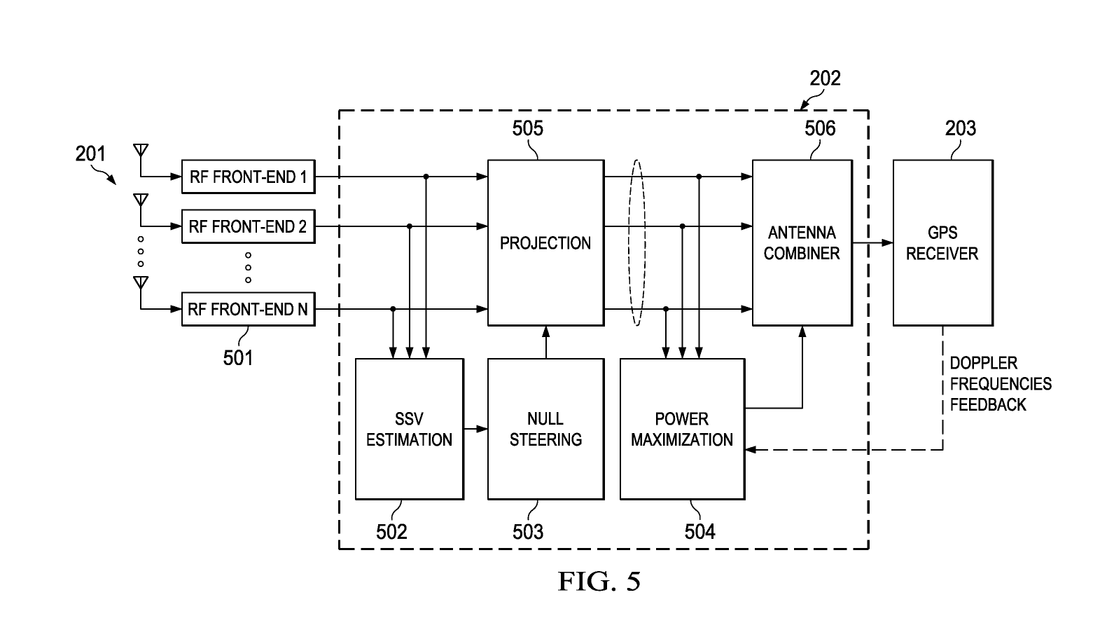

FIG. 5 is a schematic block diagram describing one embodiment of functional blocks that may be implemented in an anti-spoofing device 202. The functional blocks may be implemented as software executed in, e.g., the processing device 403. In another embodiment, the functional blocks may be hardware defined. In further embodiments, the functional blocks may be implemented as a hybrid of hardware and software. One of ordinary skill in the art will recognize a variety of processing devices 403 that may be used in accordance with the present embodiments. For example, the processing device 403 may be a microcontroller or microprocessor, a Digital Signal Processor (DSP), or the like, a Programmable Logic Chip (PLC), or the like.

Embodiments of the anti-spoofing method may be implemented by functional blocks including a spoofing SSV estimation unit 502, a null steering unit 503, and power maximization unit(s) 504. In addition, the antenna array 102 may be coupled to front-end RF equipment 501. The anti-spoofing device 202 may further include a projection unit 504 and an antenna combiner 505. The antenna combiner 505 may provide a signal to the GPS/GNSS Receiver 203.

The spoofing and authentic signals are spread over the GPS bandwidth and are buried below the noise floor. As such, it is hard to detect them before despreading. The conventional despreading process requires an extensive two-dimensional search in time and frequency domains to obtain the proper code delay and Doppler frequency for each signal. However, the spoofer spatial information can be extracted at a much lower computational complexity using the spoofing SSV estimation unit 502. This technique relies on the presence of a dominant spatial power in order to extract the spoofing SSV without any need for a two-dimensional time and frequency search for individual authentic and spoofing PRN codes. For this purpose, two characteristics of spoofing signals are described. First, the spoofer 101 is a point source transmitting several PRN codes each of which having a comparable power level to that of the authentic signals. Therefore, the energy of all spoofing signals is accumulated constructively in spatial domain and as such the overall spatial energy of the spoofing signals is considerably higher than that of the authentic signals. The second characteristic is the periodicity of the spoofing and authentic signals which is due to the inherent periodicity of PRN codes utilized in their structures.

In one embodiment, vector y is constructed as

$$y = [ \begin{matrix}{β}_{1} {e}^{j {θ}_{1}} \\ {β}_{2} {e}^{{jθ}_{2}} \\ ⋮ \\ {β}_{N} {e}^{j {θ}_{N}}\end{matrix} ] \qquad ( 7 )$$

where

$${θ}_{i} = \{ \begin{matrix}1 & i = 1 \\ • ( {\sum }_{n = 0}^{K - 1} {r}_{i} ( {nT}_{s} ) {r}_{1}^{*} ( {nT}_{s} ) ) & i = 2 , 3 , … , N\end{matrix} \\ {β}_{i} = {( \vert {\sum }_{n = 0}^{K - 1} {r}_{i} ( {nT}_{s} ) {r}_{i}^{*} ( {nT}_{s} - T ) \vert )}^{\frac{1}{2}} \\ i = 1 , 2 , … , N \qquad ( 8 )$$

and K is the number of samples which are averaged and T is one epoch interval (one period of PRN codes). In (8), spatial information of received spoofing signals has been extracted by multiplying different terms whose noise parts are spatially or temporally uncorrelated to one another to avoid noise amplification. θᵢ is approximately equal to

$$\begin{matrix}{θ}_{i} = • ( {\sum }_{n = 0}^{K - 1} {r}_{i} ( {nT}_{s} ) {r}_{1}^{*} ( {nT}_{s} ) ) \\ = • ( {C}_{i} {\sum }_{n = 0}^{K - 1} ( {\overline{b}}_{i} {\sum }_{k = 1}^{{N}_{Spoof}} {p}_{k}^{s} + {\sum }_{m = 1}^{{N}_{Auth}} {{p}_{m}^{a} ( {\overline{a}}_{m} )}_{i} ) ) \\ \approx • ( {C}_{i} {\overline{b}}_{i} K {\sum }_{k = 1}^{{N}_{Spoof}} {p}_{k}^{s} ) \\ = • {C}_{i} + • {\overline{b}}_{i 1} .\end{matrix} \qquad ( 9 )$$

In this relation, the approximation comes from the fact that the spatial energy of authentic terms are not summed up constructively while the spatial energy of spoofing terms are combined constructively, and all other crosscorrelation and noise terms are significantly reduced after temporal filtering (averaging over K samples). In (8), βᵢ can be approximated as

$$d = {( K {\sum }_{k = 1}^{{N}_{Spoof}} {p}_{k}^{s} {e}^{j 2 π {f}_{k}^{s} T} + K {\sum }_{m = 1}^{{N}_{Auth}} {p}_{m}^{a} {e}^{j 2 π {f}_{m}^{a} T} )}^{\frac{1}{2}} . \qquad ( 10 )$$

in which d is a constant complex value which is equal to

$$d = {( K {\sum }_{k = 1}^{{N}_{Spoof}} {p}_{k}^{s} {e}^{j 2 π {f}_{k}^{s} T} + K {\sum }_{m = 1}^{{N}_{Auth}} {p}_{m}^{a} {e}^{j2π {f}_{m}^{a} T} )}^{\frac{1}{2}} . \qquad ( 11 )$$

In (10), the noise terms and all other crosscorrelation terms between different PRN codes, which are not despread, are significantly reduced after averaging. By substituting θᵢ from (9) and βᵢ from (10) in (7), y becomes

$$y • [ \begin{matrix}d \\ d \vert {C}_{2} \vert {e}^{j• {C}_{2} + j• {\overline{b}}_{2}} \\ ⋮ \\ d \vert {C}_{N} \vert {e}^{j• {C}_{N} + j • {\overline{b}}_{N}}\end{matrix} ] = dC \overline{b} = db . \qquad ( 12 )$$

Hence, the spoofing SSV multiplied by a constant complex value is computed by applying the above processing technique.

In one embodiment, the null steering unit 503 may compute values for steering nulls to the direction of the spoofer 101. From (12), the orthogonal projection to the spoofing subspace can be obtained as

$${P}_{⊥} = {I}_{N \times N} - {y ( {y}^{H} y )}^{- 1} {y}^{H} . \qquad ( 13 )$$

Hence, f can be obtained as

f=P_{⊥}h, (14)

where h is an N×1 arbitrary vector with ∥h∥=1. It can be verified that f in (14) satisfies the relation in (5) as

$$\begin{matrix}{f}^{H} b = {{h}^{H} ( {P}_{⊥} )}^{H} b \\ = {h}^{H} {P}_{⊥} b \\ = {h}^{H} ( I - {y ( {y}^{H} y )}^{- 1} {y}^{H} ) {d}^{- 1} y \\ = {d}^{- 1} {h}^{H} ( y - {y ( {y}^{H} y )}^{- 1} {y}^{H} y ) \\ = {d}^{- 1} {h}^{H} ( y - y ) \\ = 0\end{matrix} \qquad ( 15 )$$

Thus, if the orthogonal projection is applied to vector r as

$$\begin{matrix}x ( {nT}_{s} ) = {P}_{⊥} r ( {nT}_{s } ) \\ = {\sum }_{m = 1}^{{N}_{Auth}} {P}_{⊥} {a}_{m} \sqrt{{p}_{m}^{a}} {F}_{m}^{a} ( {nT}_{s} ) + \\ {P}_{⊥} b {\sum }_{k = 1}^{{N}_{Spoof}} \sqrt{{p}_{k}^{s}} {F}_{k}^{s} ( {nT}_{s} ) + {P}_{⊥} η ( {nT}_{s} ) ,\end{matrix} \qquad ( 16 )$$

the spoofing signals are removed from the received antenna array signals for further antenna array processing. Moreover, by substituting f from (14) into (6) as

$$\begin{matrix}v ( {nT}_{s} ) = {h}^{H} {P}_{⊥}^{H} r ( {nT}_{s} ) \\ = {\sum }_{m = 1}^{{N}_{Auth}} {h}^{H} {P}_{⊥}^{H} {a}_{m} \sqrt{{p}_{m}^{a}} {F}_{m}^{a} ( {nT}_{s} ) + \\ {h}^{H} {P}_{⊥}^{H} b {\sum }_{k = 1}^{{N}_{Spoof}} \sqrt{{p}_{k}^{s}} {F}_{k}^{s} ( {nT}_{s} ) + {h}^{H} {P}_{⊥}^{H} η ( {nT}_{s} ) ,\end{matrix} \qquad ( 17 )$$

v(nTₛ) is obtained in which the spoofing signals are removed. This signal can be fed to conventional GNSS receivers.

In one embodiment, the power maximization unit 504 may maximize the power of the actual GNSS signals with reference to the spoofer signals. As mentioned before, h is an arbitrary vector. In (17), depending on the value of h, term h^{H}P_{⊥}^{H}aₘ may cause amplification for some authentic signals or it may cause attenuation for those signals located in or close to the beam pattern null. The proposed null steering method can be extended to the case that not only suppresses the spoofing signals but also has maximum output power for each authentic signal by choosing different values for h. Considering (17), the power of mth authentic signal after projection is maximized if

$$h = {h}_{m} = \frac{{P}_{⊥}^{H} {a}_{m}}{‖ {P}_{⊥}^{H} {a}_{m} ‖} . \qquad ( 18 )$$

In fact, term h^{H}P_{⊥}^{H}aₘ in (17) is maximized if the equation in (18) is held. Since aₘ s are unknown SSVs (depending on array configuration, satellite position and gain/phase mismatch of antenna elements), they cannot be directly estimated. However, it will be shown that hₘ s can be estimated if the estimates of Doppler frequencies of authentic signals are available (e.g. one approach can take advantage of estimated Doppler frequencies from tracking loop feedbacks of the receiver). To this end, a low computational complexity process is proposed. The conjugate of one period of the reference antenna signal is employed to remove PRN codes of vector x in (16). The output sample vector at wth snapshot is

$$\begin{matrix}z [ w ] = {\sum }_{k = 0}^{K - 1} x ( {nT}_{s} + wT ) {r}_{1}^{*} ( {nT}_{s} ) \\ = {\sum }_{n = 0}^{K - 1} {P}_{⊥} r ( {nT}_{s} + wT ) {r}_{1}^{*} ( {nT}_{s} ) \\ = {\sum }_{n = 0}^{K - 1} ( \begin{matrix}( \begin{matrix}{\sum }_{m = 1}^{{N}_{Auth}} {P}_{⊥} {a}_{m} \sqrt{{p}_{m}^{a}} {F}_{m}^{a} ( {nT}_{s} + wT ) + \\ {P}_{⊥} b {\sum }_{k = 1}^{{N}_{Spoof}} \sqrt{{p}_{k}^{s}} {F}_{k}^{s} ( {nT}_{s} + wT ) + \\ {P}_{⊥} η ( {nT}_{s} + wT )\end{matrix} ) \times \\ {( \begin{matrix}{\sum }_{m = 1}^{{N}_{Auth}} \sqrt{{p}_{m}^{a}} {F}_{m}^{a} ( {nT}_{s} ) + \\ {\sum }_{k = 1}^{{N}_{Spoof}} \sqrt{{p}_{k}^{s}} {F}_{k}^{s} ( {nT}_{s} ) + {η}_{1} ( {nT}_{s} )\end{matrix} )}^{*}\end{matrix} ) \\ • K {\sum }_{m = 1}^{{N}_{Auth}} {p}_{m}^{a} {P}_{⊥} {a}_{m} {e}^{j 2 π {f}_{m}^{a} Tw} + \hat{η} .\end{matrix} \qquad ( 19 )$$

By knowing fₘ for the mth authentic signal, the exponential term can be removed from this signal. Averaging over L snapshots results in the reduction of other authentic signals as

$$\begin{matrix}{q}_{m} = {\sum }_{w = 1}^{L} z [ w ] {e}^{- j 2 π {f}_{m}^{a} Tw} \\ = {\sum }_{w = 1}^{L} {\sum }_{{m}^{′} = 1}^{{N}_{Auth}} {Kp}_{{m}^{′}}^{a} {P}_{⊥} {a}_{m} \cdot {e}^{j2π {f}_{{m}^{′}}^{a} Tw} {e}^{- j 2 π {f}_{m}^{a} Tw} + \\ \hat{η} {e}^{- j 2 π {f}_{m}^{a} Tw} \\ = {KLp}_{m}^{a} {P}_{⊥} {a}_{m} + {\sum }_{w = 1}^{L} {\sum }_{{{m}^{′} = 1}_{{m}^{′} \neq m}}^{{N}_{Auth}} {Kp}_{{m}^{′}}^{a} {P}_{⊥} {a}_{m} \cdot {e}^{j2π ( {f}_{{m}^{′}}^{a} - {f}_{m}^{a} ) Tw} + \\ \hat{η} {e}^{- j 2 π {f}_{m}^{a} Tw}\end{matrix} \qquad ( 20 )$$

where the first term is the significant one. Therefore, qₘ is approximately equal to

qₘ≈KLpₘ^{a}P_{⊥}aₘ. (21)

Considering (18), for the mth authentic signal, hₘ can be estimated as

$${\hat{h}}_{m} = \frac{{q}_{m}}{‖ {q}_{m} ‖} . \qquad ( 22 )$$

Therefore by substituting ĥₘ in (14), the optimal gain vector fₘ, which maximizes the output power of the mth authentic signal and suppresses the spoofing signals, is obtained as

fₘ=P_{⊥}ĥₘ. (23)

By substituting fₘ from (23) in (6), the beamformer output that has no spoofing signals and has maximum power for the mth authentic signal is obtained as

$$\begin{matrix}{v}_{m} ( {nT}_{s} ) = {\hat{h}}_{m} {P}_{⊥}^{H} r ( {nT}_{s} ) \\ = {\sum }_{m = 1}^{{N}_{Auth}} {\hat{h}}_{m} {P}_{⊥}^{H} {a}_{m} \sqrt{{p}_{m}^{a}} {F}_{m}^{a} ( {nT}_{s} ) + \\ {\hat{h}}_{m} {P}_{⊥}^{H} b {\sum }_{k = 1}^{{N}_{Spoof}} \sqrt{{p}_{k}^{s}} {F}_{k}^{s} ( {nT}_{s} ) + {\hat{h}}_{m} {P}_{⊥}^{H} η ( {nT}_{s} ) \\ \approx {\sum }_{m = 1}^{{N}_{Auth}} {\hat{h}}_{m} {P}_{⊥}^{H} {a}_{m} \sqrt{{p}_{m}^{a}} {F}_{m}^{a} ( {nT}_{s} ) .\end{matrix} \qquad ( 24 )$$

The projection block 505 removes the spoofing signals from the received signal vector and the antenna combiner 506 combines different branches of spoofing free signals. When a Doppler feedback is present, the power maximization block 504 can maximize the received SNR for individual authentic PRNs and generate different outputs (vₘ) corresponding to different authentic PRNs. Otherwise, an arbitrary weighting vector (h) will be considered for antenna combining and generating a single output (v).

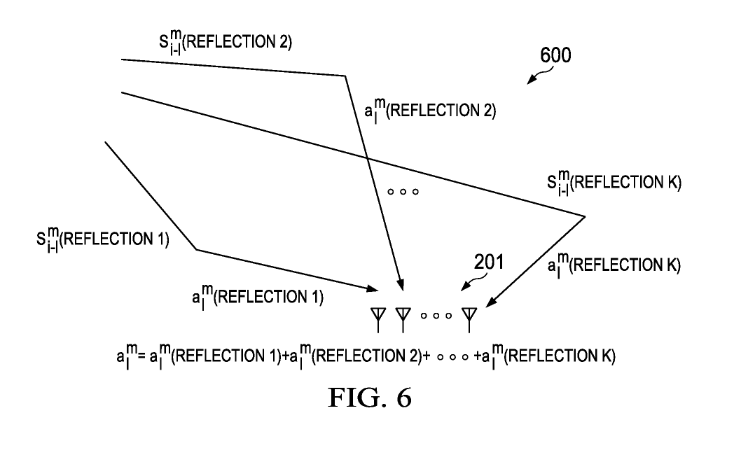

FIG. 6 is a schematic block diagram illustrating one embodiment of a GNSS system in a multipath environment 600. The spoofing mitigation becomes more challenging in multipath environments 600 where the reflections of the spoofer signal also exist. Although these components usually have lower power than the LOS spoofing signal, they may mislead the GNSS receivers 203 if they are not mitigate properly. Detecting these multipath components is more difficult than detecting the LOS component. Furthermore considering this fact that the spoofing and authentic signals are received far below the noise floor, it is a ticklish subject to differ between resolvable multipath components of the spoofing signal and the authentic signals using only spatial processing.

Herein, in order to identify the multipath components of a spoofing signal, the techniques used for blind channel estimation of multi input multi output (MIMO) systems can be applied especially those ones which are based on the second order statistics (SOS). The estimates of channel coefficients by employing both spatial and temporal processing are related to the SSVs of the incident signals. By estimating the SSVs of the spoofing signal and its reflections, then a beamformer is designed to put nulls in the direction of these undesired signals.

Assume that an antenna array has arbitrary configuration with N elements. M authentic GNSS signals and one spoofing signal (plus its multipath components) are received by this antenna array. Without loss of generality, m=0 is assumed as the spoofing signal index (from hereafter, the spoofing PRNS are not represented separately. Instead, a single signal which includes all its PRNs is denoted as a spoofing signal). For simplicity, one sample per chip has been assumed (the method can be extended to the multi-rate/multi-antenna scenario). Moreover, assume that the maximum available delay for multipath components among all desired and undesired signals is equal to L_{Ch} Chips. Received N×1 baseband signal vector of all incident signals can be expressed as

$${{r}_{i}}_{N \times 1} = {\sum }_{m = 0}^{M} {\sum }_{l = 0}^{{L}_{Ch}} {a}_{l}^{m} {s}_{i - l}^{m} + {η}_{i} \qquad ( 25 )$$

where sᵢ₋ₗ^{m} is the sample of mth signal for ith time index received with the delay of l compared to the LOS signal. ηᵢ is spatial-temporal white Gaussian noise vector and aₗ^{m} is an (N×1) vector that represents the channel coefficients for the signal components of mth received signal whose delay are l samples compared to the LOS component. In fact, aₗ^{m} is related to the combination of SSVs (or in the case of calibrated array, the array manifold vectors or steering vectors) of all signal components received with the same delay.

In one embodiment, the anti-interference device 202 may find an optimal gain vector denoted by f to satisfy the following conditions:

f^{H}aₗ⁰=0 if (aₗ⁰)^{H}aₗ⁰>λ_{Th} l=0,1, . . . L_{Ch}

∥f∥=1 (26)

where λ_{Th} is a threshold set from relative power of the spoofing signal and authentic ones which can be obtained from channel coefficient estimates. The constraint avoids the trivial solution which is an all zero vector. By applying f to the received antenna array signal vector, the spoofing signal and its multipath reflections are suppressed in the beamformer output.

As mentioned before, it is hard to discriminate between resolvable multipath components of the spoofing signal from the authentic signals by only spatial processing. By considering the signal model as (25) and forming the correlation matrix from spatial samples over P consecutive snapshots P>L_{Ch}, the correlation coefficients can be estimated. The augmented correlation matrix can be formed as follows. In (25), rᵢ can be expressed in more compact form as

$${{r}_{i}}_{N \times 1} = {\sum }_{l = 0}^{{L}_{Ch}} {A}_{l} {s}_{i - l} + {η}_{i} \qquad ( 27 )$$

where

$${{A}_{l}}_{N \times ( M + 1 )} = [ \begin{matrix}{a}_{l}^{0} & {a}_{l}^{1} & … & {a}_{l}^{M}\end{matrix} ] , l = 0 , 1 , … , {L}_{Ch} \\ {{s}_{i}}_{( M + 1 ) \times 1} = [ \begin{matrix}{s}_{i}^{0} \\ {s}_{i}^{1} \\ ⋮ \\ {s}_{i}^{M}\end{matrix} ] . \qquad ( 28 )$$

Assume that the vector \vec{r}ᵢ is formed from P consecutive snapshots as

$${{r}^{->}}_{i} = {[ \begin{matrix}{r}_{i} \\ {r}_{i - 1} \\ ⋮ \\ {r}_{i - ( P - 1 )}\end{matrix} ]}_{NP \times 1} . \qquad ( 29 )$$

It can be verified that

\vec{r}ᵢ= [symbol] \vec{s}ᵢ+\vec{η}ᵢ (30)

where [symbol] is a block Toeplitz matrix defined as

$$\begin{matrix}{𝒜}_{NP \times ( M + 1 ) ( {L}_{Ch} + P )} = [ \begin{matrix}{A}_{0} & {A}_{1} & … & {A}_{{L}_{Ch}} & 0 & … & … & 0 \\ 0 & {A}_{0} & {A}_{1} & … & {A}_{{L}_{Ch}} & ⋱ & ⋱ & 0 \\ 0 & ⋱ & ⋱ & ⋱ & ⋱ & ⋱ & ⋱ & ⋮ \\ ⋮ & ⋱ & 0 & {A}_{0} & … & {A}_{{L}_{Ch} - 1} & {A}_{{L}_{Ch}} & 0 \\ 0 & … & … & 0 & {A}_{0} & … & {A}_{{L}_{Ch} - 1} & {A}_{{L}_{Ch}}\end{matrix} ] & ( 31 ) \\ {{s}^{->}}_{i} = {[ \begin{matrix}{s}_{i} \\ {s}_{i - 1} \\ ⋮ \\ {s}_{i - {L}_{Ch} - P + 1}\end{matrix} ]}_{( M + 1 ) ( {L}_{Ch} + P ) \times 1} \\ {{η}^{->}}_{i} = {[ \begin{matrix}{η}_{i} \\ {η}_{i - 1} \\ ⋮ \\ {η}_{i - {L}_{Ch} - P + 1}\end{matrix} ]}_{NP \times 1} . & ( 32 )\end{matrix}$$

Noise and the received signals are assumed to be independent. Hence, the correlation matrix is equal to

$${ℛ}_{NP \times NP} = E \{ {{r}^{->}}_{i} {{r}^{->}}_{i}^{H} \} = 𝒜 E \{ {{s}^{->}}_{i} {{s}^{->}}_{i}^{H} \} {𝒜}^{H} + {σ}^{2} {I}_{NP \times NP} \qquad ( 33 )$$

where σ² is the variance of the noise and I is an identity matrix.

For simplicity, it may be assumed that the received PRN codes are uncorrelated. (i.e. they either have different PRN codes or their corresponding delays are different. It may also be assumed that the spoofing signals are not synchronized with the authentic signals. Therefore, due to the autocorrelation and cross correlation property of the PRN codes, correlation between each pair (including both spoofing and authentic PRN codes) of them is negligible. Hence, E{\vec{s}ᵢ\vec{s}ᵢ^{H}} can be assumed as a block diagonal matrix as

$$E \{ {{s}^{->}}_{i} {{s}^{->}}_{i}^{H} \} = 𝒜 = [ \begin{matrix}Λ & 0 & … & 0 \\ 0 & Λ & ⋱ & ⋮ \\ ⋮ & ⋱ & ⋱ & 0 \\ 0 & … & 0 & Λ\end{matrix} ] . \qquad ( 34 )$$

Assume that Ā is defined as

$$\begin{matrix}{\overline{A}}_{NP \times ( M + 1 )} = [ \begin{matrix}{{{a}^{->}}^{0}}_{NP \times 1} & {{{a}^{->}}^{1}}_{NP \times 1} & … & {{{a}^{->}}^{M}}_{NP \times 1}\end{matrix} ] \\ = [ \begin{matrix}{{A}_{0}}_{N \times ( M + 1 )} \\ {A}_{1} \\ ⋮ \\ {A}_{{L}_{ch}} \\ {0}_{N \times 1} \\ ⋮ \\ 0\end{matrix} ] \\ = [ \begin{matrix}{a}_{0}^{0} & {a}_{0}^{1} & … & {a}_{0}^{M} \\ {a}_{{1}^{0}} & {a}_{1}^{1} & ⋱ & {a}_{1}^{M} \\ ⋮ & ⋮ & ⋱ & ⋮ \\ {a}_{{L}_{Ch} - 1}^{0} & {a}_{{L}_{Ch} - 1}^{1} & ⋱ & {a}_{{L}_{Ch} - 1}^{M} \\ {0}_{N \times 1} & 0 & ⋱ & 0 \\ ⋮ & ⋮ & ⋱ & ⋮ \\ 0 & 0 & … & 0\end{matrix}\end{matrix} \qquad ( 35 )$$

The first column of Ā include the all sufficient information for suppressing the spoofing signal and its reflections. By developing the OPDA for the case that the diagonal elements of Λ in (34) are not equal (due to different power of the incident signals), it can be shown that \vec{a}⁰ can be estimate by performing the following singular value decomposition (SVD) as

SVD(Δ−J^{N}Δ(J^{N})^{H}) (36)

such that \vec{a}⁰ is approximately equal to the singular vector corresponding to the largest singular value of matrix Δ−J^{N}Δ(J^{N})^{H}. In (36), J is a shifting matrix defined as

$${J}_{NP \times NP} = [ \begin{matrix}0 & 1 & 0 & … & 0 \\ 0 & 0 & 1 & ⋱ & 0 \\ ⋮ & ⋱ & ⋱ & ⋱ & ⋮ \\ 0 & 0 & 0 & ⋱ & 1 \\ 0 & 0 & 0 & … & 0\end{matrix} ] \qquad ( 37 )$$

and Δ can be obtained from the correlation matrix [symbol] .

By dividing the estimated \vec{a}⁰ to P segments and comparing each segment to a threshold denoted by λ_{Th}, delays and theirs corresponding channel coefficients at which there are potential reflections of the spoofing signal can be detected. For l=0, 1, . . . , L_{Ch}, if (aₗ⁰)^{H a}ₗ⁰>λ_{Th}, aₗ⁰ is deemed as a steering vector of a multipath component or combination of the steering vectors of several multipath components. Assume B delays are detected and the corresponding channel coefficients are put in a N×B matrix defined as B. Matrix P_{⊥} which is orthogonal projection to the spoofing subspace can be obtained as

$${{P}_{⊥}}_{N \times N} = I - {B ( {B}^{H} B )}^{- 1} {B}^{H} . \qquad ( 38 )$$

Thus, if the orthogonal projection is applied to the received signal vector as P_{⊥}rᵢ, the spoofing signal is removed from the received antenna array 201 signals.

In multipath-free (i.e., open sky) case or in the case of presence of unresolvable multipath components, the L_{Ch}=0 and P=1. The correlation matrix in (33) reduces to

$${R}_{N \times N} = E \{ {r}_{i} {r}_{i}^{H} \} = {A}_{0} E \{ {s}_{i} {s}_{i}^{H} \} {A}_{0}^{H} + {σ}^{2} {I}_{N \times N} \qquad ( 39 )$$

that only includes spatial samples. In this case the channel coefficient (or SSV) of the spoofing signal a₀⁰ can be estimated from the following eigenvalue problem

$${Max}_{‖ μ ‖ = 1} {μ}^{H} R μ \qquad ( 40 )$$

where μ is equal to the eigenvector corresponding to the largest eigenvalue of R. Hence, the orthogonal projection to the spoofing subspace can be obtained as

$${{P}_{⊥}}_{N \times N} = I - {μ ( {μ}^{H} μ )}^{- 1} {μ}^{H} . \qquad ( 41 )$$

In one embodiment, the second largest eigenvector maximizes the power of the authentic signal components. Therefore, choosing this vector as the array gain vector allows the power of the authentic signals pass through the beamformer as much as possible whereas the spoofing signal is suppressed.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. An apparatus for spoofing countermeasures comprising:
an input configured to receive a plurality of signals from an array of antenna elements;
a processing unit coupled to the inputs and configured to pre-process the plurality of signals from the array of antenna elements with a combining for suppressing a spoofing component in the signals and generating a combined signal for further processing; and
an output coupled to the processing unit and configured to provide the combined signal for further processing.

2. The apparatus of claim 1, wherein the processing unit is configured to compute pairwise numerical correlations of all the outputs from the antenna outputs with a single channel selected from the same set of inputs are calculated that are used to compute weighting coefficients that are applied to the input signals resulting in a weighted combined output.

3. The apparatus of claim 1, wherein the processing unit is configured to calculate the weighting coefficients in response to:
the absolute values of pairwise correlations of a delayed version of inputs with a single input selected from the same set of inputs; and
the correlations, where the computed weighting coefficients are applied to the plurality of inputs resulting in a weighted combined output.

4. The apparatus of claim 1, wherein the antenna array is configured to receive a superposition of GNSS signals from independent transmitter sources and a spoofing signal and its several multipath reflections originating from a single transmitter source.

5. The apparatus of claim 1, wherein the processing unit calculates pairwise numerical correlations of all the inputs for a certain time interval, where the correlation sums are assembled into a covariance matrix where the covariance matrix is used to generate the combining weights and where the weighted sum is passed to the output port of the processing unit.

6. The apparatus of claim 5, wherein the processing unit is configured to apply a modified version of an outer product decomposition algorithm (OPDA), constrained optimization method or prediction methods or the subspace method to the covariance matrix in order to estimate the spatial characteristics of the line of sight spoofing signal and its multipath reflections to form the orthogonal projection matrix onto the spoofing subspace.

7. The apparatus of claim 6, wherein the processing unit compares the spatial characteristics of the multipath reflections for each delay to a threshold to detect and estimate the spatial characteristics of the potential reflections of the spoofing signal, and to use the spatial characteristics of the line of sight spoofing signal and its potential reflections to form the orthogonal projection matrix used to compute weighting coefficients that are applied to the processing unit inputs resulting in a weighted combined output.

8. The apparatus of claim 7, wherein the processing unit is further configured to calculate pairwise numerical correlation sums of all the input samples, where these correlation sums are assembled into a covariance matrix and where the eigenvector corresponding to the second largest eigenvalue of this covariance matrix is used as combining weights and where the weighted sum is passed to the output port of the processing unit in response to the multipath being received with delays less than one chip duration of the GNSS signal or when no reflection is present.

9. The apparatus of claim 1, further comprising a pre-processing block configured to normalize the amplitude of the input signals such that the variances of the outputs of the antennas are the same.

10. The apparatus of claim 1, further comprising a user control input that in one position invokes the processing implied by the previous claims and in the other position bypasses the weighting and connects one or more of the input antennas to one or more of the output ports to the GNSS receiver.

11. The apparatus of claim 1, further comprising an automatic spoofer sensing device configured to automatically trigger the processing unit in response to a determination that a spoofing signal is detected, and if no spoofer is detected then the processing unit is automatically switched off.

12. The apparatus of claim 1, wherein the apparatus is a stand-alone device configured to be coupled between the array of antenna elements and a GNSS/GPS receiver.

13. The apparatus of claim 1, wherein the further processing comprises conventional GNSS/GPS processing conducted by a GNSS/GPS processor.

14. The apparatus of claim 1, wherein the processing unit is integral with a GNSS/GPS processor.

15. An apparatus comprising:
a plurality of RF to IF down-convertors corresponding to each antenna element in an antenna array coupled to the one or more RF to IF down converters, the RF to IF down converters configured to down-convert the frequency band of received GNSS signals from RF frequencies to a lower IF frequency;
a plurality of analog to digital converter coupled to the one or more RF to IF down-converters and configured to sample the input IF signals into digital domain;
a processing unit configured to pre-process the one or more signals from the array of antenna elements with a combining for suppressing a spoofing component in the signals and generating a plurality of combined signals for further processing;
a plurality of digital to analog converters coupled to the processing unit and configured to convert the output digital samples into IF analog signals; and
a plurality of IF to RF up-convertors coupled to the digital to analog converters and configured to up-convert the IF outputs of the digital to analog converters into RF signals.

16. The apparatus of claim 15, where the processing unit is configured to compute pairwise numerical correlations of the plurality of inputs with a single input selected from the same set of inputs are calculated, and the correlations are used to compute a plurality of weighting coefficients based on an orthogonal projection matrix that is applied to the plurality of inputs resulting in a plurality of weighted combined outputs.

17. The apparatus of claim 15, wherein the processing unit is configured to calculate the weighting coefficients in response to:
the absolute values of pairwise correlations of a delayed version of inputs with a single input selected from the same set of inputs;
the correlations, where the computed weighting coefficients are applied to the plurality of inputs resulting in a weighted combined output, wherein the orthogonal projection matrix is employed to compute a plurality of weighting coefficient sets; and
wherein the computed weighting coefficients are then applied to the plurality of inputs resulting in plurality of weighted combined outputs.

18. The apparatus of claim 15, wherein the processing unit wherein the processing unit is further configured to calculate pairwise numerical correlation sums of all the input samples, where these correlation sums are assembled into a covariance matrix and where the eigenvector corresponding to the second largest eigenvalue of this covariance matrix is used as combining weights and where the weighted sum is passed to the output port of the processing unit in response to the multipath being received with delays less than one chip duration of the GNSS signal or when no reflection is present, and a second output of the processing unit is generated from a weighting based on the 3rd largest eigenvalue resulting in two output ports of the device.

19. The apparatus of claim 18, wherein the 4th to the Nth eigenvectors corresponding to the 4th to the Nth largest eigenvalues are used as weighting coefficients forming N−1 outputs based on the device having N antennas.

20. The apparatus of claim 15, further comprising a user control input that in one position invokes the processing implied by the previous claims and in the other position bypasses the weighting and connects one or more of the input antennas to one or more of the output ports to the GNSS receiver.

21. The apparatus of claim 15, further comprising an automatic spoofer sensing device configured to automatically trigger the processing unit in response to a determination that a spoofing signal is detected, and if no spoofer is detected then the processing unit is automatically switched off.

22. A method comprising:
receiving a plurality of GNSS signals including one or more authentic GNSS signals and one or more spoofed GNSS signals on an antenna array;
pre-processing the one or more signals from the array of antenna elements with a combining for suppressing a spoofing component in the signals and generating a combined signal for further processing; and
providing the combined signal for further processing.
